(19) United States
(12) Patent Application Publication
(10) Pub. No.: US 2021/0216984 A1
(43) Pub. Date: Jul. 15, 2021

(54) Method and System for Licensing, Aggregating, Formatting, Distributing, and Monetizing Copyrighted Short-Form Promotional Content through an Entertainment Channel

(71) Applicant: The Preview Channel, Inc., Clearwater, FL (US)

(72) Inventor: William Sager, Clearwater, FL (US)

(21) Appl. No.: 17/148,948

(22) Filed: Jan. 14, 2021

Related U.S. Application Data
(60) Provisional application No. 62/960,805, filed on Jan. 14, 2020.

(51) Int. Cl. G06Q 20/12; G06Q 50/18; G06Q 30/02; G06Q 30/06; G06F 16/27; H04N 21/234; H04N 21/81; H04N 21/472; H04N 21/643; H04N 21/478; A63F 13/792

(52) U.S. Cl. CPC G06Q 20/1235; G06Q 50/184; G06Q 30/0273; G06Q 30/0277; G06Q 30/0633; G06Q 30/0641; A63F 13/792; H04N 21/23424; H04N 21/812; H04N 21/47202; H04N 21/643; H04N 21/4781; G06F 16/27

(57) ABSTRACT

A method provides an advertisement inserted entertainment channel to deliver licensed copyrighted promotional content. The method sources and acquires various short-form promotional content materials. With the express rights, the method aggregates, formats, encodes, and converts the materials into previews using a content aggregator while keeping the original content unaltered. The method creates promotional programs by integrating the previews with advertisements and organizes the promotional programs using a content management system. Additionally, the method delivers the promotional programs to the entertainment channel in a conventional linear format, an advertising-based video on demand (AVOD), over-the-top (OTT) streaming platform, or a standalone application compatible with any personal computing device. Further, the method provides the opportunity to directly monetize from the promotional programs using the original promotional content while offering the streaming channel free to consumers. Thus, the method offers highly valuable entertainment programs with maximum flexibility and optimal monetization efficiency.

The current application claims a priority to the U.S. Provisional Patent application Ser. No. 62/960,805 filed on Jan. 14, 2020.

### FIELD OF THE INVENTION

The present invention relates generally to a streaming channel. More specifically, the present invention relates to an entertainment channel that delivers and monetizes from promotional programs combining licensed copyrighted promotional content materials with advertisements in a conventional linear television (TV) format, an advertising-based video on demand (AVOD) over-the-top (OTT) streaming platform, or a standalone application compatible with any personal computing device.

### BACKGROUND OF THE INVENTION

Motion picture, television (TV), streaming platform, and videogame producers and distributors generally produce, distribute short-form promotional digital audiovisual materials such as previews, trailers, electronic press kits, “behind-the-scenes” featurettes, and other related content to promote and advertise their productions (“promotional content” or “previews”). The promotional content typically features scenes from the productions, commentary from content performers or creators and is organized and edited in a way to favorably describe the production. The promotional content typically has very high production values and is a kind of short-form entertainment content that is widely known and highly desired by audiences as the promotional content not only informs prospective viewers about the production, but also is usually highly entertaining in and to itself. Additionally, the promotional content is well known to and rabidly sought and followed by consumers and fans. There are hundreds of thousands of new versions of short-form promotional content produced every year. Previews are typically distributed and made available for public consumption by content creators in a variety of ways. The content creators typically attach and display the previews in front of the screening of long-form content, place the previews on web sites, insert into programs that are syndicated to consumers, release the previews to entertainment broadcasting on television shows to be included in programming that promotes entertainment content or is featured on creator owned channels or platforms. Additionally, the previews are generally distributed without cost to a variety of audiovisual services, shows or web sites that attract audiences and the content creators believe that audiences will be interested and potentially view other products of the content creators. Further, the content creators will purchase advertising time on channels, shows or web sites to display promotional content to prospective audiences and/or subscribers. The content creators do not typically charge for the promotional content since the primary objective is to generate attention and interest for their productions. These content creators, however, do not typically allow third-party licensees to monetize previews. There are numerous entertainment and fan websites that display and screen promotional content, however, they are unable due to content copyright protections to directly monetize the promotional content materials. As of January 2021, there exists enormous competition amongst movie studios, streaming platforms, audiovisual apps, TV channels, smart TV's, websites and others for viewers and each year there are hundreds of thousands of new productions produced and distributed all vying for similar audiences.

A streaming channel is the digital dissemination of multi-media audiovisual content outside of the conventional “over-the-air” or cable methods, which is delivered to consumers over the Internet and which is customarily known as over-the-top (OTT) distribution (called “streaming channel”). Streaming channels are presently proliferating at a rapid pace as conventional broadcasters, distributors and producers of a wide variety of audiovisual content are actively developing their own channels to be able to access the rapidly expanding availability of streaming channels and the resulting rapidly expanding audiences and consumer base.

The present invention is a streaming channel that exclusively programs copyrighted promotional content, under license from the content creators, along with related original content, organized and formatted in themes, episodes, categories, programs and other conventional television broadcast structures, on an advertising-based video on demand (AVOD), over-the-top (OTT), standalone entertainment streaming channel offered in both on-demand and in linear formats 24 hours a day and seven days a week, which results in a unique audience viewing experience.

### SUMMARY OF THE INVENTION

The present invention provides a method and system that facilitates a streaming channel that exclusively programs promotional content and advertisements. The method of the present invention sources a wide variety of promotional content, both new and archived, and acquires various short-form copyrighted promotional content materials from content producers and/or distributors. With the express rights of the copyright owners of the promotional content materials, the method aggregates, formats, encodes, and converts the materials into previews according to predetermined specifications of the present invention using a content aggregator, while keeping the original promotional content of the acquired materials unaltered. Subsequently, the method creates promotional programs by integrating the resulting previews with advertisements from various advertisers and organizes the promotional programs in themes, episodes, categories, and any other conventional television broadcast structures using a content management system. Additionally, the method delivers to the entertainment channel in a conventional linear format, an advertising-based video on demand (AVOD), over-the-top (OTT) streaming platform, or a standalone application compatible with any personal computing device 24 hours a day and seven days a week, thus resulting in a unique audience viewing experience. The method provides the opportunity to directly monetize the promotional programs using the original promotional content by inserting advertisements while offering the streaming channel free to consumers (AVOD).

Further, the method of the present invention manages the promotional programs through a predetermined update schedule, which may include, but is not limited to, daily, weekly, monthly, or ad hoc basis via the content management system. Thus, the present invention offers highly valuable entertainment programs to consumers and users through both traditional linear broadcasting and AVOD OTT streaming with maximum flexibility and optimal monetization efficiency.

### BRIEF DESCRIPTION OF THE DRAWINGS

FIG. 1 is a flowchart of an overall process of the method of the present invention.

FIG. 2 is a flowchart of a sub-process for broadcasting promotional programs through a linear TV channel of the method of the present invention.

FIG. 3 is a flowchart of a sub-process for streaming promotional programs through an over-the-top (OTT) television (TV) channel of the method of the present invention.

FIG. 4 is a flowchart of an alternative embodiment of the sub-process for streaming promotional programs of the method of the present invention, wherein a video on demand (VoD) TV channel is provided.

FIG. 5 is a flowchart of a sub-process for acquiring copyrighted promotional content materials from one or more content creators of the method of the present invention.

FIG. 6 is a flowchart of a sub-process for creating preview media using a content management system of the method of the present invention, wherein the content management system includes a content aggregator.

FIG. 7 is a flowchart of an alternative embodiment of the sub-process for creating preview media of the method of the present invention, wherein the content aggregator uploads, encodes, and converts the promotional content materials into preview media.

FIG. 8 is a flowchart of a sub-process for creating promotional programs of the method of the present invention, wherein at least one promotional program is created through randomly inserting advertisements into the program.

FIG. 9 is a flowchart of an alternative embodiment of the sub-process for creating promotional programs of the method of the present invention, wherein advertisements are inserted into the preview per a predetermined time interval.

FIG. 10 is a flowchart of another embodiment of the sub-process for creating promotional programs of the method of the present invention, wherein an advertisement is inserted into the preview per a predetermined order.

FIG. 11 is a flowchart of another embodiment of the sub-process for creating promotional programs of the method of the present invention, wherein the promotional programs are formatted into HTTP (Hypertext Transfer Protocol) live streaming (HLS) feeds.

FIG. 12 is a flowchart of another embodiment of the sub-process for creating promotional programs of the method of the present invention, wherein the promotional programs are formatted into media Really Simple Syndication (MRSS) feeds.

FIG. 13 is a system diagram of an alternative embodiment of the method of the present invention.

FIG. 14 is a flowchart diagram of the alternative embodiment of the method of the present invention.

FIG. 15 is a flowchart of an alternative embodiment of the sub-process for sending notifications of the method of the present invention, wherein a plurality of messages for at least one newly released promotional program is relayed to a specific user.

FIG. 16 is a flowchart of an alternative embodiment of the sub-process for facilitating an interactive videogame experience of the method of the present invention, wherein a plurality of videogame programs is delivered to the specific user to try and purchase.

### DETAIL DESCRIPTIONS OF THE INVENTION

All illustrations of the drawings are for the purpose of describing selected versions of the present invention and are not intended to limit the scope of the present invention.

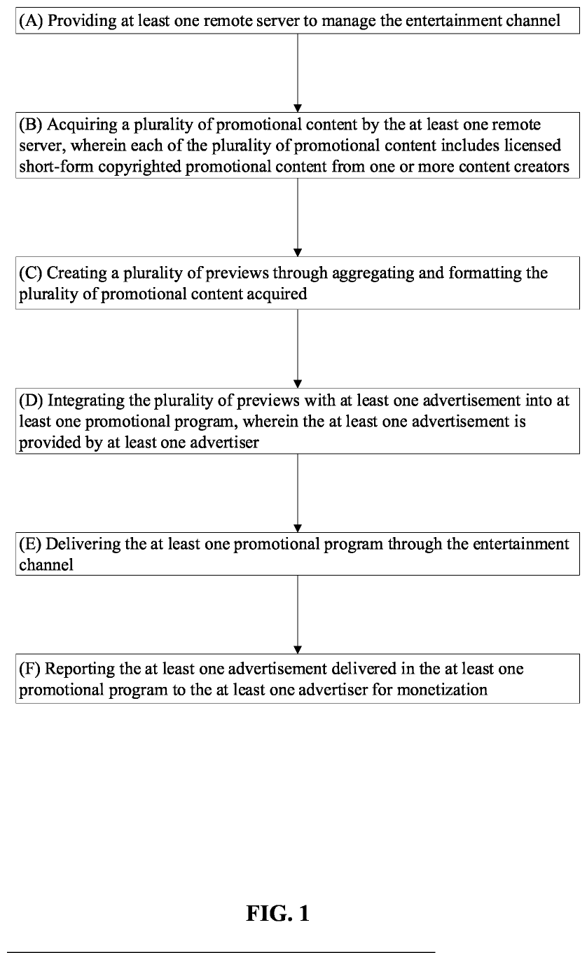

As can be seen in FIG. 1 to FIG. 16, the present invention comprises a method and system for providing an advertisement inserted entertainment channel. The method of the present invention creates promotional programs through licensing, aggregating, formatting, and converting various copyrighted short-form media of audiovisual promotional content and delivers to the entertainment channel in a conventional linear format, an advertising-based video on demand (AVOD), over-the-top (OTT) streaming platform, or a standalone application compatible with any personal computing device. The short-form media of the promotional content used in the method of the present invention primarily include, but are not limited to, trailers of motion picture, television (TV), videogame, any other promotional, and related video productions. The method acquires and licenses express right of these copyrighted materials from various content producers, creators, and/or distributors. Additionally, the method organizes and encodes the acquired materials of promotional content through a content aggregator into previews that conform to predetermined content specifications of the present invention. By integrating the previews with advertisements from various advertisers, the method creates promotional programs to be delivered to the entertainment channel. The promotional programs can be grouped and formatted into various episodes, categories, themed blocks, and viewed and consumed by a user in the same manner of conventional entertainment streaming channels. The present invention may be distributed on several OTT platforms and networks, broadcast, cable, and digital channels. The licensed promotional content may be sourced from entities including, but not limited to, major Hollywood® studios, independent film distributors, streaming subscription video services, such as Hulu®, Amazon® Prime, Netflix®, HBOMax®, Disney®+, and other audio-visual content distributors. Additionally, the present invention can be distributed via Smart TV® sets from over various different original equipment manufacturers (OEM) or television (TV) manufacturers, including, but no limited to, Sony®, LG®, Samsung®, HiSense®, Panasonic®, Funai®, TiVo® (set-top), Vizio®, Sanyo®, Sharp®, Magnavox®, and Phillips®, etc. The present invention can be implemented on two major Smart TV® platforms: Xumo® Smart TV® Platform and the Samsung® Smart TV® Platform, and, via Xumo® applications (apps), in many digital media including Amazon® Fire TV®, Roku®, Comcast® Xfinity®, T-Mobile® Metro Play®, GooglePlay®, and the Apple® App Store. The present invention can also be distributed on Sinclair Broadcasting's STIRR® OTT platform and syndication network and on Plex®.

As can be seen in FIG. 1, the method of the present invention comprises a method and system to manage an advertisement inserted entertainment channel. To accomplish this, the method provides at least one remote server to manage the entertainment channel (Step A). Then, the method acquires a plurality of promotional content by the at least one remote server, wherein each of the plurality of promotional content includes licensed short-form copyrighted promotional content from one or more content creators (Step B). More specifically, the plurality of promotional content is copyrighted and short-form entertainment material. Additionally, the plurality of promotional content may include, but is not limited to, movie trailer, TV show trailer, TV mini-series trailer, video game trailer, scene, interview, behind-the-scenes interview, etc. The plurality of promotional content may be acquired from one or more content creators, including, but not limited to, content producers, content studios, content companies, content distributors, etc. Subsequently, the method creates a plurality of previews through aggregating and formatting the plurality of promotional content acquired (Step C). Specifically, the method may download the plurality of promotional content, organize the acquired materials, formatting and encoding the materials into individual previews to be used in the creation of promotional programs to be used in the entertainment channel. Upon generating usable previews from copyrighted promotional content, the method integrates the plurality of previews with at least one advertisement into at least one promotional program, wherein the at least one advertisement is provided by at least one advertiser (Step D). Subsequently, the method delivers the at least one promotional program through the entertainment channel (Step E) and reports the viewed advertisements from the plurality of advertisements to at least one advertiser of the plurality of advertisers for monetization (Step F). Thus, the method provides a platform to monetize through streaming or broadcasting the at least one promotional program that is created from copyrighted promotional content and advertisements.

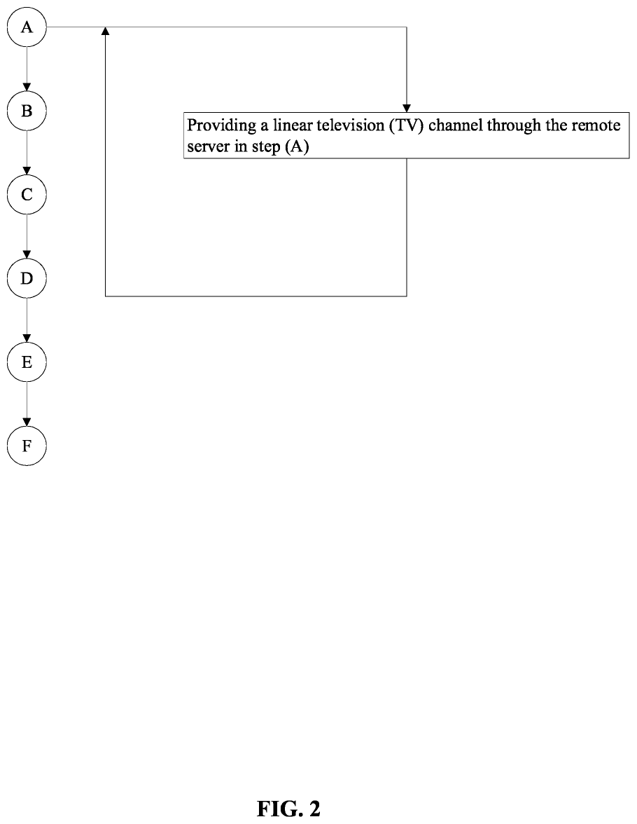

As can be seen in FIG. 2, the method of the present invention provides a sub-process for broadcasting the promotional programs through a linear television (TV) channel. More specifically, the method provides a linear TV channel through the remote server in Step A. Subsequently, the method broadcasts the at least one promotional program through the linear TV channel in Step E, wherein the broadcasting may run a predetermined schedule, including, but not limited to, varying times and length, 24 hours per day and seven days per week, or any other suitable program schedule. The linear TV channel of the method may include, but is not limited to, traditional TV, cable TV, satellite TV, Sling TV®, DirecTV®, DirecTV® Now, Hulu® with Live TV®, YouTube® TV, PlayStation® Vue, etc.

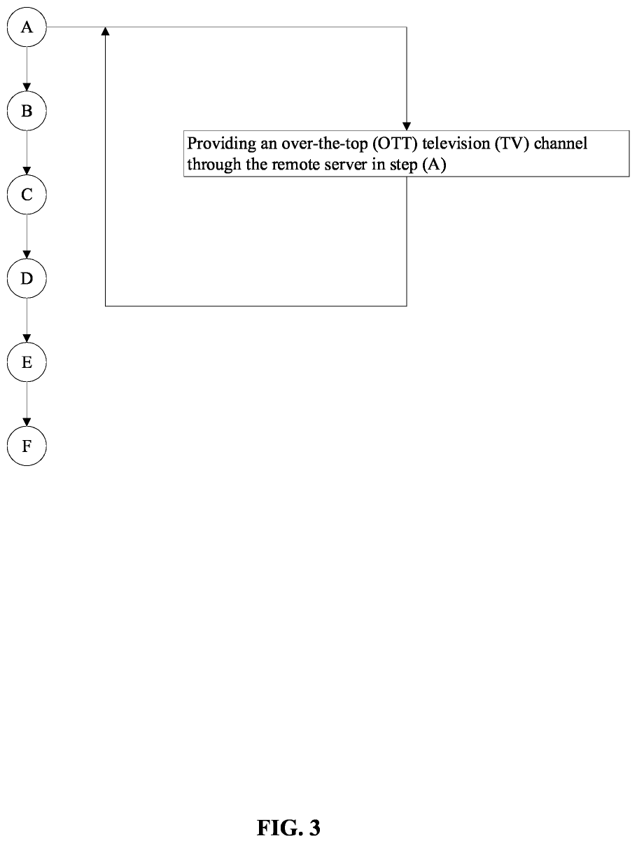

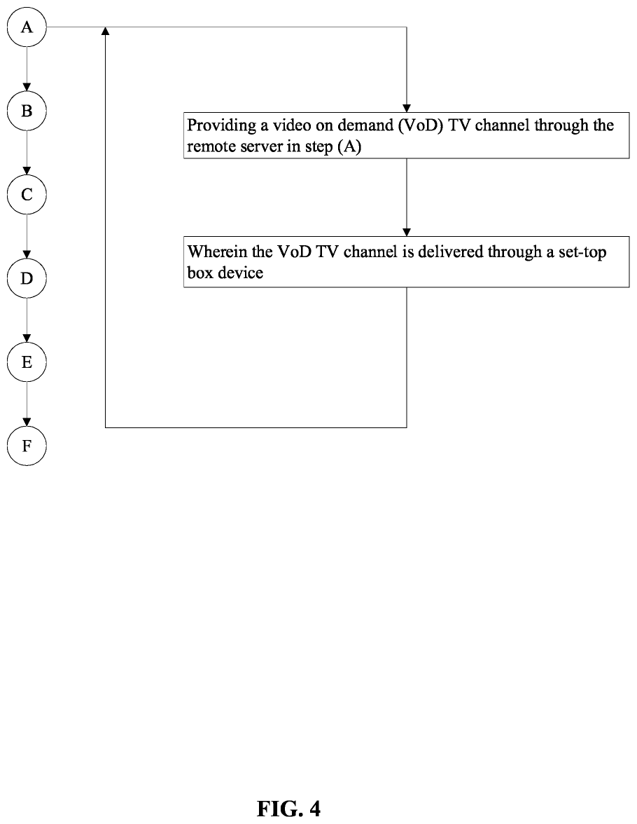

As can be seen in FIG. 3, the method of the present invention provides a sub-process for broadcasting the promotional programs through an over-the-top (OTT) television (TV) channel. More specifically, the method provides an OTT television (TV) channel through the remote server in Step A. Subsequently, the method streams the at least one promotional program through the OTT TV channel in Step E, wherein the streaming comprises a predetermined schedule, including, but not limited to, varying times and length, 24 hours per day and seven days per week, or any other suitable program schedule. The OTT streaming of the method includes, but is not limited to, CTV, IPTV, TV sets connected to the internet through built-in internet connectivity, Smart TV, set-top box (STB) devices. Apple TV, Google Chromecast, Amazon Fire, Roku. Blu-ray players, any suitable gaming consoles, AVOD, Subscription video-on-demand (SVOD), Subscription OTT, Transactional based video-on-demand (TVOD), pay-per-view (PPV), etc. As can be seen in FIG. 4, in an alternative embodiment of the present invention, the method provides a video on demand (VoD) TV channel through the remote server, wherein the VoD TV channel is delivered through a set-top box device.

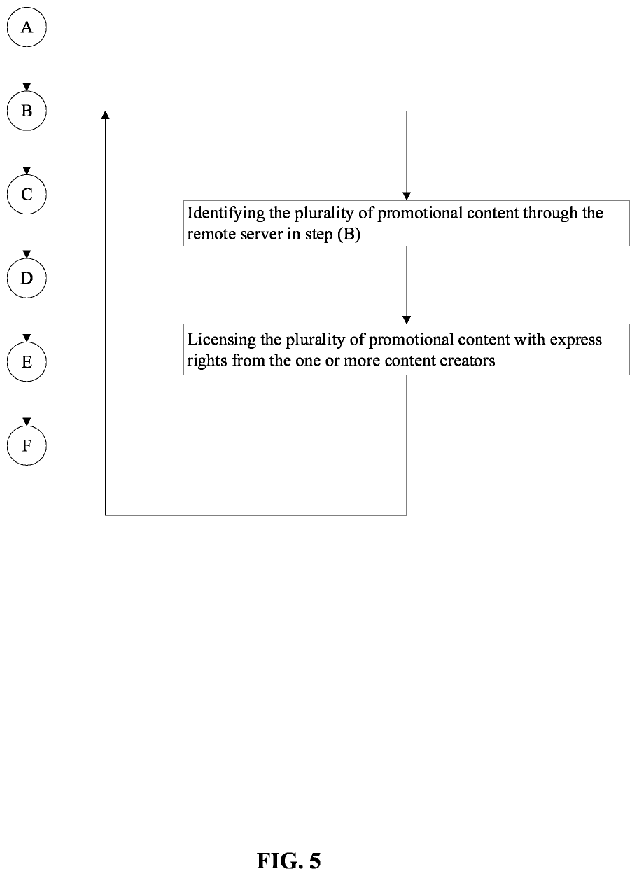

As can be seen in FIG. 5, the method provides a sub-process for acquiring copyrighted promotional content from various sources. Specifically. The method identifies the plurality of promotional content through the remote server in Step B. Subsequently, the method licenses the plurality of promotional content with express rights from the one or more content creators. The one or more content creators include, but are not limited to, content producers, movie studios, motion picture companies, TV producers, videogame producers, content distributors, etc. Through exclusive licensing of the promotional content, the method of the present invention acquires express rights for the copyrighted promotional content to be used in the promotional programs distributed and delivered through the entertainment channel.

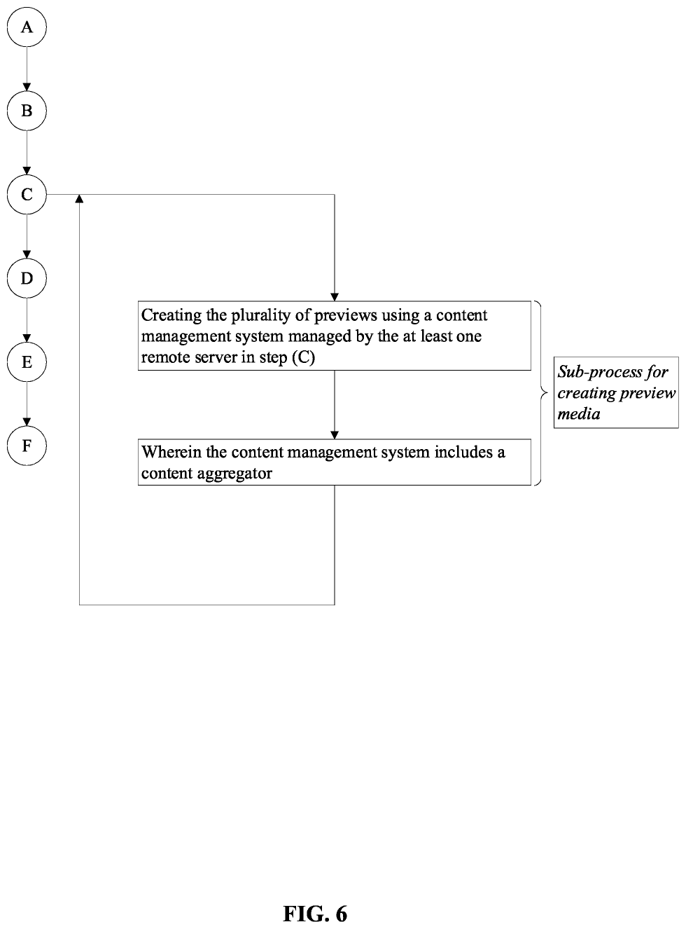

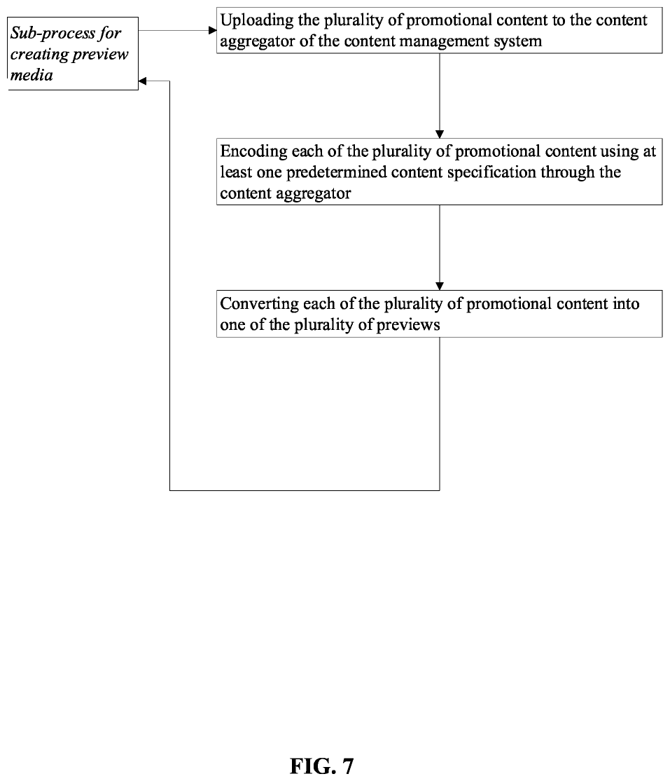

As can be seen in FIG. 6, the method provides a sub-process for creating preview media, which are the copyrighted promotional content materials acquired through licensing. The acquired promotional content materials are aggregated, formatted, encoded, and converted into the preview media in the present invention to be used in creating promotional programs. None of the promotional content of acquired materials, however, is not altered or modified. Specifically. the method creates the plurality of previews using a content management system managed by the at least one remote server in Step B, wherein the content management system includes a content aggregator. As can be seen in FIG. 7, in an alternative embodiment of the present invention, the method uploads the plurality of promotional content to the content aggregator of the content management system. Subsequently, the method encodes each of the plurality of promotional content using at least one predetermined content specification through the content aggregator and converts each of the plurality of promotional content into one of the plurality of previews.

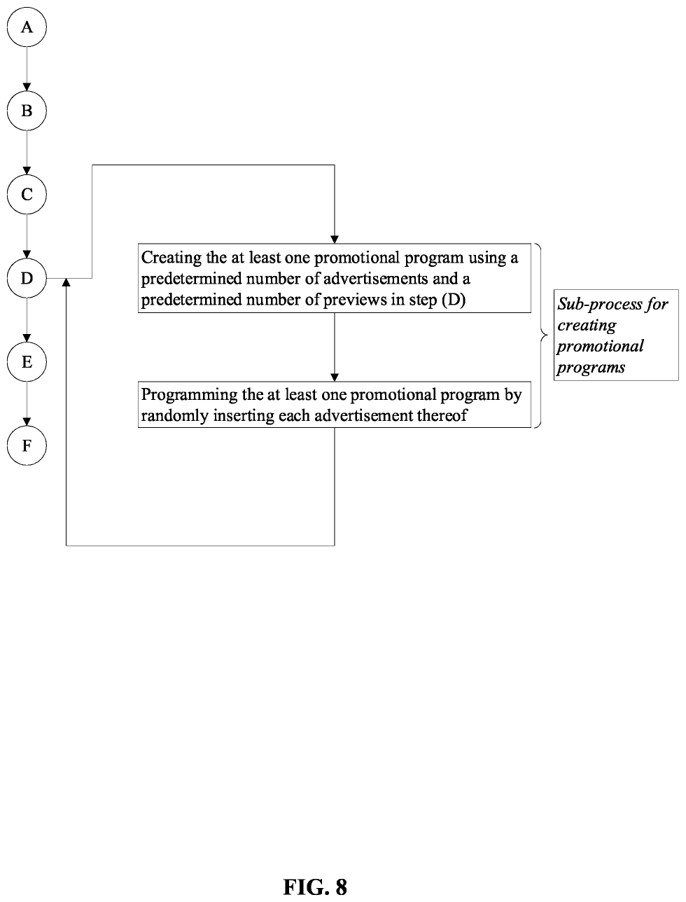

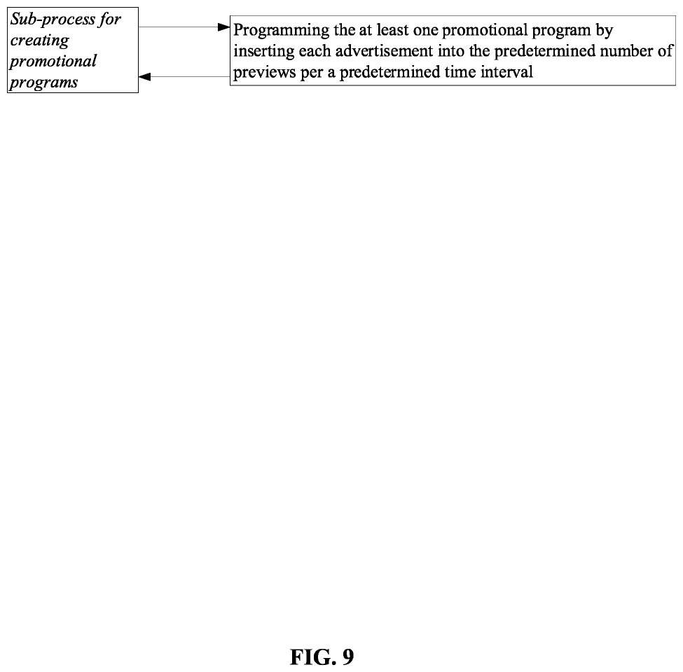

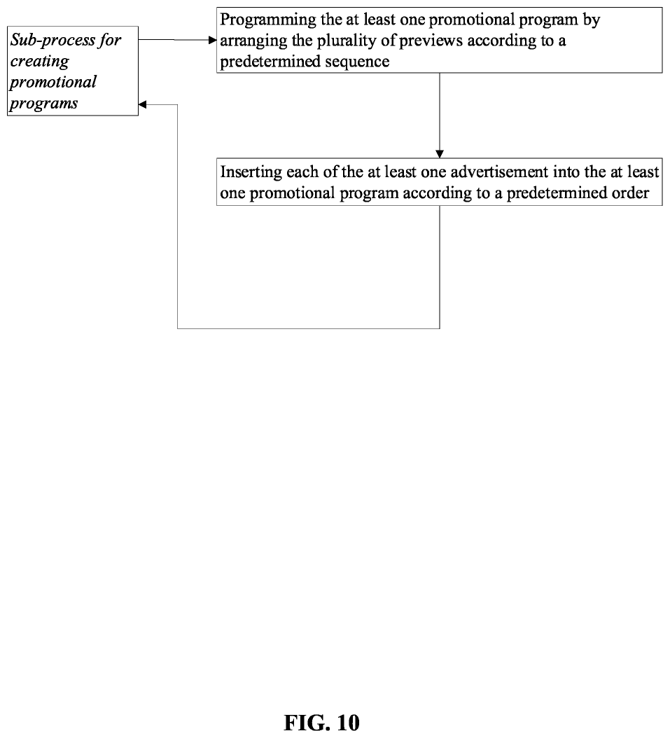

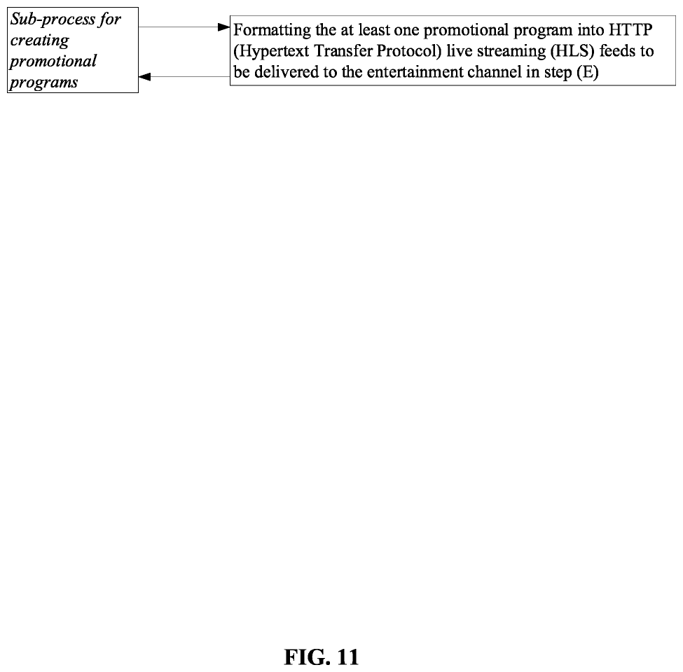

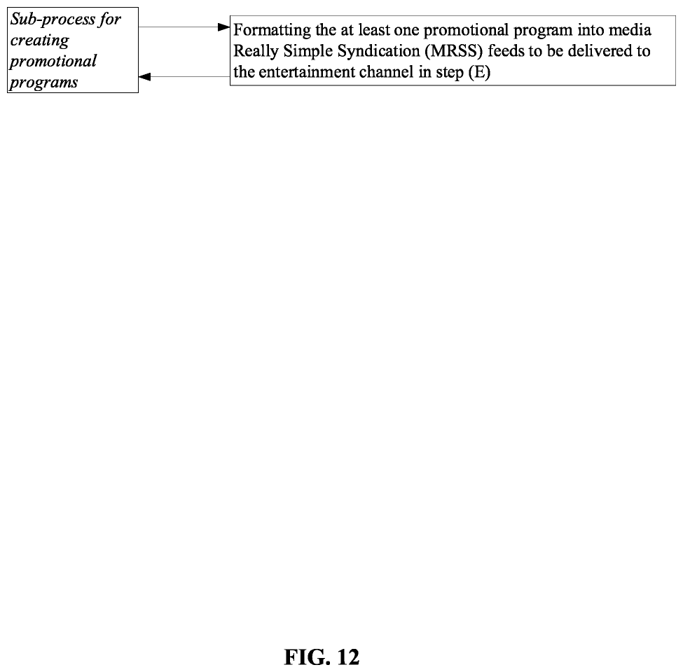

As can be seen in FIG. 8, the method provides a sub-process for creating promotional programs, which are the content to be delivered to and broadcasted through the entertainment channel of the present invention. Each promotional program includes the copyrighted promotional content materials acquired through licensing and at least one advertisement from at least one advertiser. More specifically, the method creates the at least one promotional program using a predetermined number of advertisements and a predetermined number of previews in Step D. Subsequently, the method programs the at least one promotional program by randomly inserting each advertisement thereof. As can be seen in FIG. 9, in an alternative embodiment of the present invention, the method programs the at least one promotional program by inserting each advertisement into the predetermined number of previews per a predetermined time interval. As can be seen in FIG. 10, in another embodiment of the present invention, the method programs the at least one promotional program by arranging the plurality of previews according to a predetermined sequence and inserts each of the at least one advertisement into the at least one promotional program according to a predetermined order. As can be seen in FIG. 11, in another embodiment of the present invention, the method formats the at least one promotional program into HTTP (Hypertext Transfer Protocol) live streaming (HLS) feeds to be delivered to the entertainment channel in Step E. As can be seen in FIG. 12, in another embodiment of the present invention, the method formats the at least one promotional program into a media Really Simple Syndication (MRSS) feeds to be delivered to the entertainment channel in Step E. The method, however, may include any other suitable feed formats for the promotional programs to be delivered to the entertainment channel.

The method of present invention provides a sub-process for updating the promotional programs using newly acquired copyrighted promotional content materials. This sub-process applies to situations, including, but not limited to, any original copyrighted promotional content has been changed, updated, modified by the content creator, any advertisement has been changed, updated, modified by the advertiser, etc. More specifically, the method updates the at least one promotional program per a predetermined schedule through the remote server in Step D. The predetermined schedule for updating the promotional programs of the present invention may include, but is not limited to, daily, weekly, monthly, or ad hoc basis via the content management system.

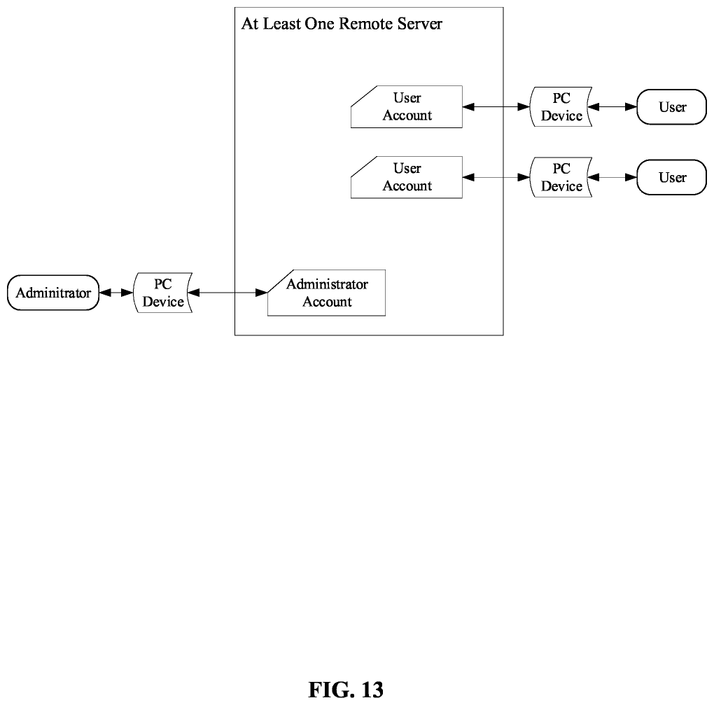

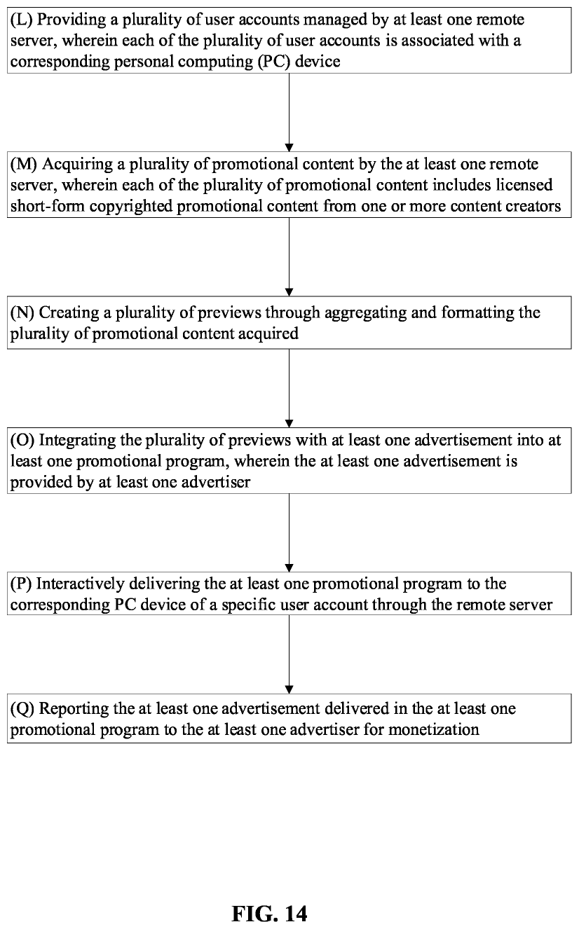

As can be seen in FIG. 13, in an alternative embodiment of the present invention, the method and system to manage an online entertainment channel platform for a plurality of user accounts. To accomplish this, the method associates each of the plurality of users with a unique user account from a plurality of user accounts that is managed by at least one remote server (Step L), as seen in FIG. 14. Each of the plurality of user accounts is associated with a corresponding personal computing (PC) device. The corresponding PC device allows the user to interact with the present invention and can include, but is not limited to, a smartphone, a smart watch, a laptop, a desktop, a server, a server computer, a cloud computing device, a cloud computer, a personal digital assistant (PDA), a server terminal, a tablet PC, a smart television (TV) set, Connected TV (CTV), Internet Protocol TV (IPTV), a Smart TV® device, Apple TV® device, Chromecast®, PlayStation®, Xbox®, Amazon® Fire stick, any other video game device, and any other streaming device, etc. The users of the plurality of user accounts may include relevant parties such as, but are not limited to, individuals, consumers, subscribers, TV subscribers, distributers, retailers, TV stations, TV device retailers, businesses, entities, managers, business owners, companies, corporations, associations, organizations, non-profit organizations, government entities, advertisers, advertisement producers, advertisement distributors, advertising companies, videogame producers, videogame vendors, entertainment companies, entertainment producers, and administrators, etc. Further, the at least one remote server is used to manage the entertainment channel system for the plurality of user accounts. The remote server can be managed through an administrator account by an administrator as seen in FIG. 13. The administrator who manages the remote server includes, but is not limited to, technician, engineer, system specialist, system administrator, software engineer, IT (information technology) specialist, IT professional, computer engineer, computer scientist, computer technologist, consultant, manager, owner, executive officer, chief operating officer, chief technology officer, chief executive officer, president, company, corporation, organization, association, etc. Moreover, the remote server is used to execute a number of internal software processes and store data for the present invention. The software processes may include, but are not limited to, server software programs, web-based software applications or browsers embodied as, for example, but not limited to, websites, web applications, cloud applications, desktop applications, laptop applications, tablet applications, TV device applications, server applications, and mobile applications, etc., compatible with a corresponding user PC device. Additionally, the software processes may store data into internal databases and communicate with external databases, which may include, but are not limited to, user profile databases, entertainment databases, promotional content databases, movie trailer databases, TV trailer databases, videogame databases, interview databases, entertainment preview databases, advertisement databases, advertiser databases, databases maintaining data about entertainment previews, etc. The interaction with external databases over a communication network may include, but is not limited to, the Internet. Additionally, the term “user” is interchangeable with “subscriber” hereafter.

As can be seen in FIG. 14, in the alternative embodiment, the overall process of the method acquires a plurality of promotional content by the at least one remote server, wherein each of the plurality of promotional content includes licensed short-form copyrighted promotional content from one or more content creators (Step M). More specifically, the plurality of promotional content acquired may include, but is not limited to, movie trailer, TV show trailer, TV mini-series trailer, video game trailer, scene, interview, behind-the-scenes interview, existing preview, any suitable short-form promotional content material, etc. With licensing the plurality of promotional content from various content creators, the present invention acquires express rights to the copyrighted materials. Subsequently, the method creates a plurality of previews through aggregating and formatting the plurality of promotional content acquired (Step N). Specifically, the method creates the plurality of previews through aggregating, formatting, encoding, and converting the promotional content materials without altering and/or modifying the actual content of the materials. Then, the method integrates the plurality of previews with at least one advertisement into at least one promotional program, wherein the at least one advertisement is provided by at least one advertiser (Step O). Subsequently, the method interactively delivers the at least one promotional program to the corresponding PC device of a specific user account through the remote server (Step P). With the viewed promotional programs through the entertainment channel, the method reports the at least one advertisement delivered in the at least one promotional program to the at least one advertiser for monetization. Thus, the method provides an online platform to monetize through streaming or broadcasting the plurality of promotional content while offering the specific user unlimited access to a wide variety of promotional content of entertainment.

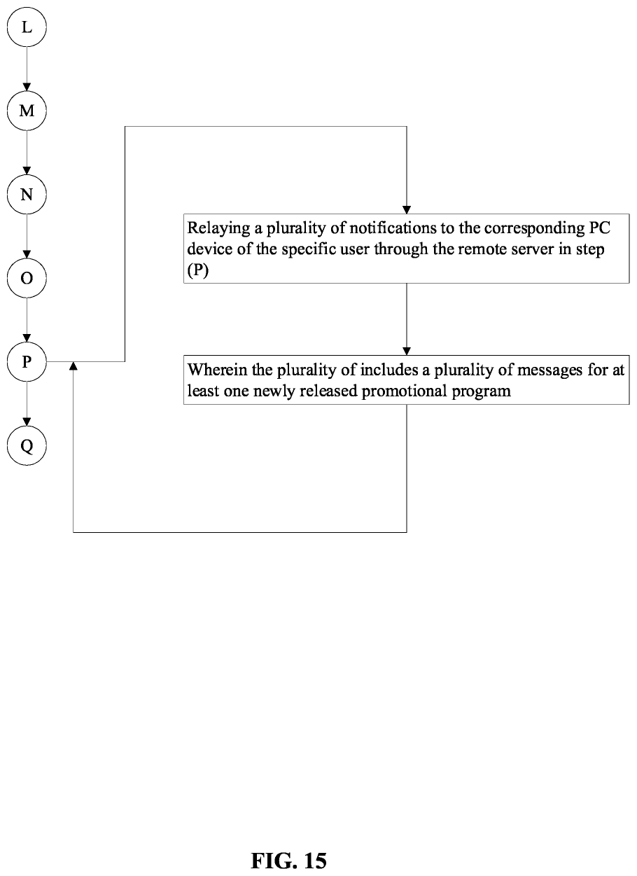

As can be seen in FIG. 15, the method provides a sub-process for sending notifications to the specific user for newly released promotional programs on the entertainment channel. More specifically, the method relays a plurality of notifications to the corresponding PC device of the specific user through the remote server in Step P, wherein the plurality of includes a plurality of messages for at least one newly released promotional program. The plurality of messages may include, but is not limited to, text message, voice message, video message, email notification, screen/console popup notice, etc.

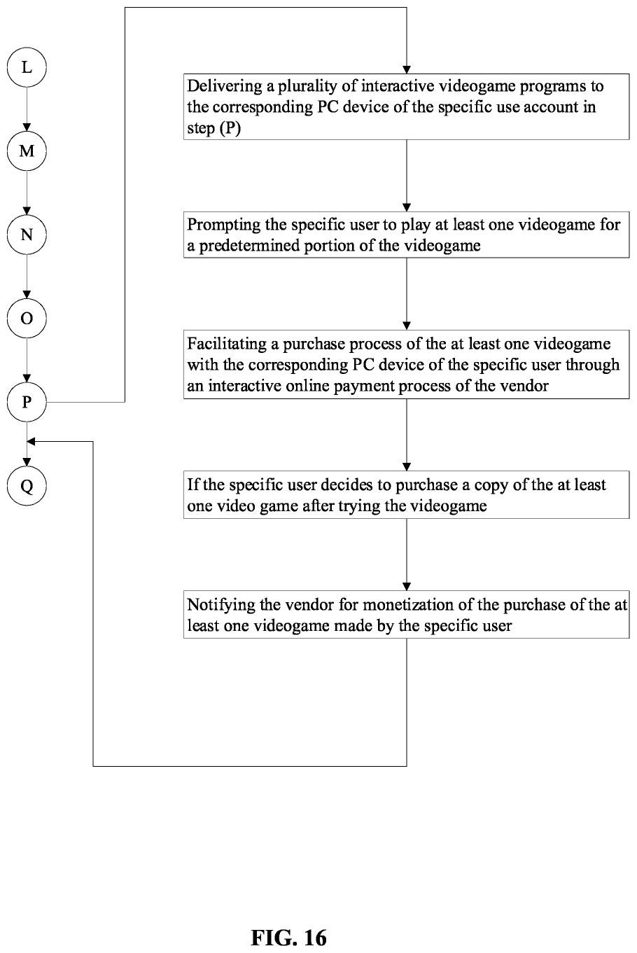

As can be seen in FIG. 16, the method provides a sub-process for facilitating an interactive videogame experience through promotional programs on the entertainment channel. More specifically, the method delivering a plurality of interactive videogame programs to the corresponding PC device of the specific use account in Step P and prompts the specific user to play at least one videogame for a predetermined portion of the videogame. Subsequently, the method facilitates a purchase process of the at least one videogame with the corresponding PC device of the specific user through an interactive online payment process of the vendor if the specific user decides to purchase a copy of the at least one videogame after trying the video game. The method notifies the vendor for monetization of the purchase of the at least one videogame made by the specific user.

Although the invention has been explained in relation to its preferred embodiment, it is to be understood that many other possible modifications and variations can be made without departing from the spirit and scope of the invention as hereinafter claimed.

What is claimed is:

1. A method for providing an advertisement inserted entertainment channel, the method comprising the steps of:
(A) providing at least one remote server to manage the entertainment channel;
(B) acquiring a plurality of promotional content by the at least one remote server, wherein each of the plurality of promotional content includes licensed short-form copyrighted promotional content from one or more content creators;
(C) creating a plurality of previews through aggregating and formatting the plurality of promotional content acquired;
(D) integrating the plurality of previews with at least one advertisement into at least one promotional program, wherein the at least one advertisement is provided by at least one advertiser;
(E) delivering the at least one promotional program through the entertainment channel; and
(F) reporting the at least one advertisement delivered in the at least one promotional program to the at least one advertiser for monetization.

2. The method for providing an advertisement inserted entertainment channel as claimed in claim 1, the method comprising the steps of:
providing a linear television (TV) channel through the remote server in step (A).

3. The method for providing an advertisement inserted entertainment channel as claimed in claim 1, the method comprising the steps of:
providing an over the top (OTT) streaming channel through the remote server in step (A).

4. The method for providing an advertisement inserted entertainment channel as claimed in claim 3, the method comprising the steps of:
providing a video on demand (VoD) TV channel through the remote server; and
wherein the VoD TV channel is delivered through a set-top box device.

5. The method for providing an advertisement inserted preview channel as claimed in claim 1, the method comprising the steps of:
identifying the plurality of promotional content through the remote server in step (B); and
licensing the plurality of promotional content with express rights from the one or more content creators.

6. The method for providing an advertisement inserted preview channel as claimed in claim 1, the method comprising the steps of:
creating the plurality of previews using a content management system managed by the at least one remote server in step (C); and
wherein the content management system includes a content aggregator.

7. The method for providing an advertisement inserted preview channel as claimed in claim 6, the method comprising the steps of:
uploading the plurality of promotional content to the content aggregator of the content management system;
encoding each of the plurality of promotional content using at least one predetermined content specification through the content aggregator; and
converting each of the plurality of promotional content into one of the plurality of previews.

8. The method for providing an advertisement inserted preview channel as claimed in claim 1, the method comprising the steps of:
creating the at least one promotional program using a predetermined number of advertisements and a predetermined number of previews in step (D); and
programming the at least one promotional program by randomly inserting each advertisement thereof.

9. The method for providing an advertisement inserted preview channel as claimed in claim 8, the method comprising the steps of:
programming the at least one promotional program by inserting each advertisement into the predetermined number of previews per a predetermined time interval.

10. The method for providing an advertisement inserted preview channel as claimed in claim 8, the method comprising the steps of:
programming the at least one promotional program by arranging the plurality of previews according to a predetermined sequence; and
inserting each of the at least one advertisement into the at least one promotional program according to a predetermined order.

11. The method for providing an advertisement inserted preview channel as claimed in claim 8, the method comprising the steps of:
formatting the at least one promotional program into HTTP (Hypertext Transfer Protocol) live streaming (HLS) feeds to be delivered to the entertainment channel in step (E).

12. The method for providing an advertisement inserted preview channel as claimed in claim 8, the method comprising the steps of:
formatting the at least one promotional program into media Really Simple Syndication (MRSS) feeds to be delivered to the entertainment channel in step (E).

13. The method for providing an advertisement inserted preview channel as claimed in claim 1, the method comprising the steps of:
updating the at least one promotional program per a predetermined schedule through the remote server in step (D).

14. The method for providing an advertisement inserted preview channel as claimed in claim 13, the method comprising the steps of:
updating the at least one promotional program on a daily basis.

15. A method for providing an advertisement inserted entertainment channel, the method comprising the steps of:
(L) providing a plurality of user accounts managed by at least one remote server, wherein each of the plurality of user accounts is associated with a corresponding personal computing (PC) device
(M) acquiring a plurality of promotional content by the at least one remote server, wherein each of the plurality of promotional content includes licensed short-form copyrighted promotional content from one or more content creators;
(N) creating a plurality of previews through aggregating and formatting the plurality of promotional content acquired;
(O) integrating the plurality of previews with at least one advertisement into at least one promotional program, wherein the at least one advertisement is provided by at least one advertiser;
(P) interactively delivering the at least one promotional program to the corresponding PC device of a specific user account through the remote server; and
(Q) reporting the at least one advertisement delivered in the at least one promotional program to the at least one advertiser for monetization.

16. The method for providing an advertisement inserted preview channel as claimed in claim 15, the method comprising the steps of:
relaying a plurality of notifications to the corresponding PC device of the specific user through the remote server in step (P); and
wherein the plurality of includes a plurality of messages for at least one newly released promotional program.

17. The method for providing an advertisement inserted preview channel as claimed in claim 15, the method comprising the steps of:
delivering a plurality of interactive videogame programs to the corresponding PC device of the specific use account in step (P);
prompting the specific user to play at least one videogame for a predetermined portion of the videogame;
facilitating a purchase process of the at least one videogame with the corresponding PC device of the specific user through an interactive online payment process of the vendor;
if the specific user decides to purchase a copy of the at least one videogame after trying the video game; and
notifying the vendor for monetization of the purchase of the at least one videogame made by the specific user.
